(19) United States
(12) Patent Application Publication
(10) Pub. No.: US 2014/0017987 A1
(43) Pub. Date: Jan. 16, 2014

(54) AIR SUPPLY ARRANGEMENT

(71) Applicant: VOLVO CAR CORPORATION, Gothenburg (SE)

(72) Inventor: Erik Andersson, Savedalen (SE)

(21) Appl. No.: 13/940,463

(22) Filed: Jul. 12, 2013

(30) Foreign Application Priority Data
Jul. 12, 2012 (EP) 12176174.6

(51) Int. Cl. B60H 1/28

(52) U.S. Cl. CPC B60H 1/28
USPC 454/147

(57) ABSTRACT

An air supply arrangement for a vehicle comprises a housing including an air inlet adapted to receive an air stream from outside of the vehicle and an outlet adapted to convey the air stream to a vehicle climate control system. The arrangement further comprises a cowl provided within the housing. The cowl is arranged for splitting the air stream into at least two air stream portions including a first air stream portion that is able to pass between the cowl and a top portion of the housing, and a second air stream portion that is able to pass below the cowl. A vehicle comprising such an air supply arrangement is also provided.

### CROSS-REFERENCE TO RELATED APPLICATIONS

This application claims foreign priority benefits under 35 U.S.C. §119(a)-(d) to European patent application number EP 12176174.6, filed Jul. 12, 2012, which is incorporated by reference in its entirety.

### TECHNICAL FIELD

The present disclosure relates to an air supply arrangement for a vehicle and further relates to a vehicle comprising such an air supply arrangement.

### BACKGROUND

Many modern vehicles are provided with a climate control system, e.g., an HVAC system, i.e., a heating, ventilation and air conditioning system, in order to provide a comfortable climate in the passenger compartment. Typically, fresh air is supplied to the climate control system from ambient air outside of the vehicle through an air supply arrangement.

Sometimes, precipitation, such as rain, snow or hail, may be present in the outside air and may also further be carried by the air into the air supply arrangement. However, this is undesirable since, if moist or water enters the climate control system, there is a risk of a bad smell arising or water entering the passenger compartment. Moreover, the precipitation may reduce the efficiency of the climate control system, and there may even be a risk of damaging the climate control system. There is therefore a wish to, at least partly, prevent precipitation from entering the climate control system of the vehicle.

Patent document DE 43 03 663 C1 discloses an air supply arrangement for a vehicle. An air inlet is provided between the bonnet and the windscreen, through which fresh air can enter the air supply arrangement. The air stream passes above a cowl until it reaches the edge of the cowl, where the air stream changes direction by about 180 degrees when passing the edge. The edge of the cowl is provided with a precipitation collection means in order to prevent at least some of the precipitation caught by the cowl from reaching the climate control system of the vehicle.

However, the cowl creates a pressure drop for the air, which counteracts the air flow requirements for the climate control system. The air supply arrangement is therefore dimensioned large enough to allow sufficient air to enter the climate control system.

On the other hand, it is known that the larger the air supply arrangement is, the more space is needed in the vehicle for housing the air supply arrangement. Therefore, there is a desire to reduce the size of the air supply arrangement.

Moreover, there is also a desire to reduce the speed of air through the air supply arrangement. This reduces the energy used to operate the air supply arrangement. A reduced speed of the air also results in a reduced risk of carrying precipitation with the air.

There is hence a need for an improved air supply arrangement, which is able to supply sufficient air to the climate control system, which at least partly prevents precipitation from reaching the climate control system, and which yet has a compact size.

### SUMMARY

An object of the present disclosure is to overcome or ameliorate at least one of the disadvantages of the prior art, or to provide a useful alternative.

It is desirable to provide an air supply arrangement being able to supply sufficient air, at least partly preventing precipitation, and yet having a compact size.

Thus, in a first aspect of the present disclosure there is provided an air supply arrangement for a vehicle. The air supply arrangement comprises
a housing, the housing comprising an air inlet adapted to receive an air stream from outside of the vehicle and an outlet adapted to convey the air stream to a vehicle climate control system, and
a cowl provided within the housing,

wherein the cowl is arranged such that the air stream is split into at least two air stream portions, whereof a first air stream portion passes between the cowl and a top portion of the housing, and a second air stream portion passes below the cowl.

The air supply arrangement is thus able to supply sufficient air, at least partly prevents precipitation, and yet has a compact size.

Further, since the air stream is split into at least two air stream portions, the speed of the air may be reduced as compared to prior art solutions using only one of the above-mentioned air stream portions.

The cowl is arranged within the housing, such that it redirects the entering air stream. The cowl may for example prevent the entering air stream from directly reaching the outlet of the air supply arrangement, which outlet is positioned at a rear wall of the housing and is adapted to convey the air to the climate control system of the vehicle. Thereby the cowl helps to prevent precipitation from reaching the climate control system. The cowl may be arranged such that its projection on the rear wall of the housing substantially covers the area of the outlet. However, due to the higher density of the precipitation, e.g., water drops, as compared to the air, the cowl is useful also for the case, wherein its projection on the rear wall does not cover a lower portion of the outlet, since the water drops in the second air stream portion will hit the rear wall of the housing below the outlet, although the air stream passes through the outlet. In a similar way, the cowl is useful also for the case, wherein its projection on the rear wall does not cover an upper portion of the outlet, since the water drops in the first air stream portion will hit the rear wall of the housing above the outlet, although the air stream passes through the outlet. In an alternative embodiment, the size and position of the cowl may be such that its projected area on the rear wall is larger than the outlet.

The cowl may be a separate unit which is attached to the housing during assembly of the air supply arrangement. In that case, the cowl may be slid downwards in corresponding grooves of the housing, thereby making it possible to mount the cowl without any use of special tools. In addition, or as an alternative, the cowl may be attached by any other known fastening means to the interior of the housing, such as a clip, a screw or a nut and bolt connection or by welding or gluing. Alternatively, the cowl may be integrated in the housing, e.g., by being formed in one unit with the housing.

The housing is normally provided with a drainage system comprising at least one drainage opening, such that precipitation trapped in the air supply arrangement can be drained from the air supply arrangement. The drainage opening is preferably provided with a valve arrangement, such that air is prevented from entering the air supply arrangement through the drainage opening.

The top portion of the housing comprises the air inlet and a portion located above an upper edge of the cowl. There may also be an intermediate portion in between the air inlet and the portion located above the upper edge of the cowl. The portion located above the upper edge of the cowl, may be air tight, thereby forming a path for first air stream portion. The top portion of the housing may have a flat upper side. Alternatively, a portion of it may be located vertically above or below another portion, for example the air inlet may be located vertically above, below or at the same level as the portion enclosing the upper edge of the cowl.

In an embodiment comprising one cowl, the first air stream portion passes above the cowl and the second air stream portion passes below the cowl.

In an embodiment comprising a stack of cowls arranged interspaced on top of each other inside the housing, the first air stream portion passes between the uppermost cowl and the top portion of the housing, and a second air stream portion passes below the lowest cowl. An additional air stream portion may pass in between at least two of the cowls in the stack.

In both cases, i.e., the air supply arrangement comprising one cowl or a plurality of cowls, there is an air stream portion passing above the uppermost cowl.

It would also be possible that the cowl comprises an opening, which allows air to pass through the cowl. In that case, another air stream portion will pass through that opening. Anyway, according to the disclosure, there is a first air stream portion passing between the cowl and a top portion of the housing, and a second air stream portion passing below the cowl.

The air stream portion passing between the cowl and a top portion of the housing is a desired air stream and thus not any leakage air. At least 5%, preferably at least 10% and most preferably at least 15% of the air stream entering the air supply arrangement may go in the first air stream portion. The amount of air going in the first air stream portion depends on the number of cowls. If a stack of cowls is used, the entering air stream will be split into a plurality of air stream portions and hence less air will go in the first air stream portion as compared to an embodiment having only one cowl. The amount of air going in the respective air stream portions may be selected by means of the design of the cowl and the housing. Further, the air going in the respective air stream portions may be controlled by flaps or valve arrangements.

A main portion of the cowl may form a substantially vertical wall when mounted in the vehicle, as seen in a cross-sectional view. This shape differs from that of many existing cowls, which comprises a substantially horizontal portion. The direction may deviate a few degrees, e.g., less than 15 degrees, from vertical. This makes the wall easy to assemble in the housing, e.g., by sliding it downwards in the above-mentioned grooves.

The cowl may have a curved shape when seen from above.

In an embodiment, the shape cowl is step-shaped when seen in cross-section from the side of the vehicle. It comprises a first substantially vertical portion, a second substantially vertical portion being substantially parallel to the first portion and an intermediate transition portion joining the first and second portions. The second substantially vertical portion is often larger than the first substantially vertical portion. The second substantially vertical portion may form the main portion of the cowl.

A portion of at least one lateral edge of the cowl may be attached to the housing. In case the main portion of the cowl forms a substantially vertical wall, when mounted in the vehicle, the lateral edge may also be substantially vertical and thus easy to slide e.g., in the above-mentioned grooves. The cowl may be attached to the housing only at at least a portion of one of or both of its lateral edges. This differs from many existing cowls, which are attached to the housing at their substantially horizontal portion.

The cowl may comprise a precipitation collection means arranged to collect precipitation carried by the first or second air stream portion from the outside of the vehicle and to remove the precipitation from that air stream portion. The precipitation collection means may be located at, or adjacent to, a lower or upper edge of the cowl. In case the cowl has a step-shaped cross-section, a precipitation collection means may be present at the inter-mediate transition portion. One or more precipitation collection means may be used. The precipitation collection means may be in the form of a gutter along the upper or lower edge of the cowl. The precipitation collection means may be connected to the above-mentioned drainage opening by a drainage system. Purely as an example, the above-mentioned stopper of the groove may be used for draining a precipitation collection means located at the lower edge of the cowl.

In an embodiment, wherein the cowl is to be slid in grooves during assembly of the air supply arrangement, the sliding movement may be stopped by a stopper at the lower end of the groove, which stopper may also form a part of the drainage system of the air supply arrangement. In addition, the stopper may be used to retain the cowl in position after assembly, such that the cowl cannot be displaced upwards. The stopper may for example snap fit to the cowl, e.g., around the intermediate transition portion, if the cowl is step-shaped, or around a precipitation collection means at the lower edge of the cowl.

In an embodiment, the upper edge of the cowl is located at a higher vertical level than the air inlet, when the air supply arrangement is mounted in the vehicle. This helps to prevent precipitation from reaching the outlet.

The cowl may change the direction of the first air stream portion by at least 90 degrees, when passing the upper edge of the cowl.

The upper edge of the cowl may be located at a position being rearward of the air inlet, when the air supply arrangement is mounted in the vehicle. This helps to prevent precipitation from reaching the outlet.

The housing may comprises a protrusion protruding into the housing to a position being vertically below the upper edge of the cowl, the protrusion being located forward of the upper edge of the cowl, when the air supply arrangement is mounted in the vehicle. This helps to prevent precipitation from reaching the outlet. The protrusion may be a wall protruding into the housing from example the rear edge of the air inlet. The protrusion may also be formed by a step in the shape of the top portion of the housing. The protrusion may be provided with a precipitation collection means.

The portion of the housing, which is located over the cowl, may be air tight, thereby forming a path for the first air stream portion.

By using an adapter between the housing and the air inlet, it is possible to use the same shape of the housing for different vehicle models having different heights of the bonnet. The adapter may have the same cross-section as the air inlet. Alternatively, the adapter could also encompass the portion of the housing located above the upper edge or the whole top portion of the cowl. For some embodiments, the adapter preferably comprises one or more of the features comprised in the housing described above. Purely as an example, the adapter may comprise a protrusion or a precipitation collection means.

The adapter is preferably arranged such that an air-tight connection is formed to the rest of the housing.

Examples of suitable materials for the housing and the cowl are plastics, e.g., injection-moulded, and/or metal. The choice of material is preferably made having factors such as cost, production efficiency and vehicle safety in mind. If using injection-moulded plastics, the cowl and the housing may be moulded as one unit, or they may be moulded separately and then assembled.

In a second aspect of the present disclosure there is provided a vehicle comprising an air supply arrangement according to above.

### BRIEF DESCRIPTION OF THE DRAWINGS

The present disclosure will hereinafter be further explained by means of non-limiting examples with reference to the appended figures wherein:

FIG. 1 is a schematic overview of a vehicle comprising an air supply arrangement according to the disclosure;

FIG. 2 is a perspective, partly cross-sectional view of a first embodiment of the disclosure seen from within a passenger compartment;

FIG. 3 is a cross-sectional side view of the first embodiment;

FIG. 4 is a perspective view of a cross-section of a second embodiment of the disclosure;

FIG. 5 is a cross-sectional side view of a third embodiment of the disclosure;

FIG. 6 is a cross-sectional side view of a fourth embodiment of the disclosure;

FIG. 7 is a cross-sectional side view of a fifth embodiment of the disclosure; and

FIG. 8 is a cross-sectional side view of a sixth embodiment of the disclosure.

It should be noted that the appended drawings are not necessarily drawn to scale and that the dimensions of some features of the present disclosure may have been exaggerated for the sake of clarity.

### DETAILED DESCRIPTION

The invention will, in the following, be exemplified by embodiments. It should however be realized that the embodiments are included in order to explain principles of the invention and not to limit the scope of the invention, as defined by the appended claims. Details from two or more of the embodiments may be combined with each other.

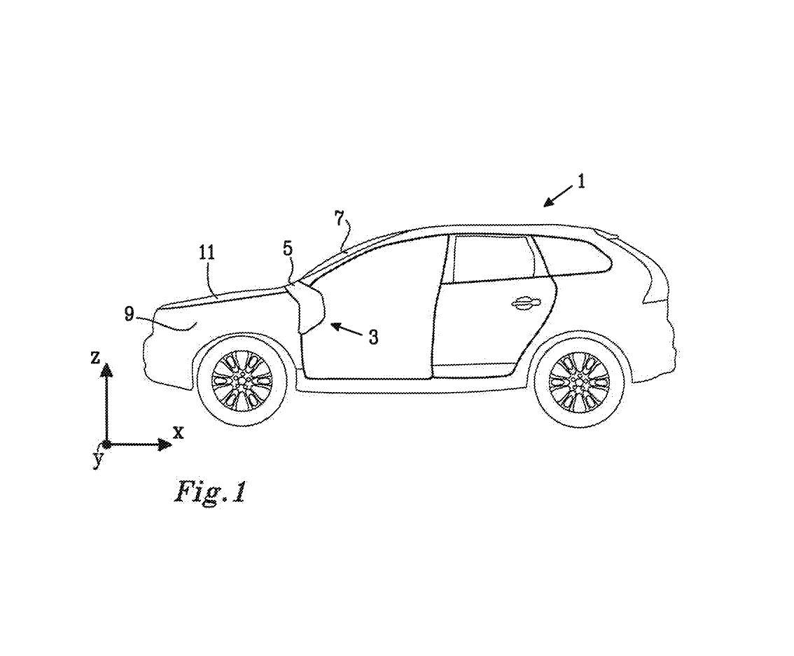

FIG. 1 schematically illustrates a vehicle 1 comprising an air supply arrangement 3 according to the disclosure. Typically, the air supply arrangement 3 is arranged in a region 5 between a windshield 7 and an engine compartment 9 of the vehicle. Alternatively, at least parts of the air supply arrangement, such as the air inlet, may be arranged in a bonnet 11 of the vehicle 1.

Terms like vertical, horizontal, upper, lower, lateral, in front of and rearward of as used herein relate to when the air supply arrangement 3 according to the disclosure is mounted in the vehicle 1, which stands on substantially flat ground. However, the air supply arrangement may be manufactured and sold as a separate unit.

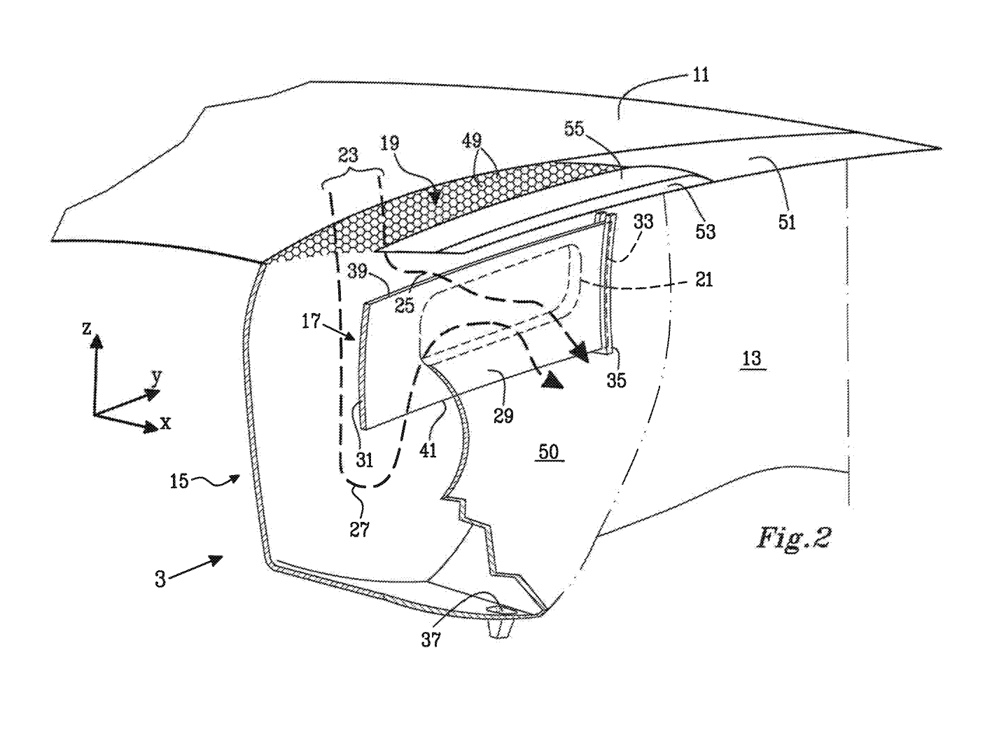

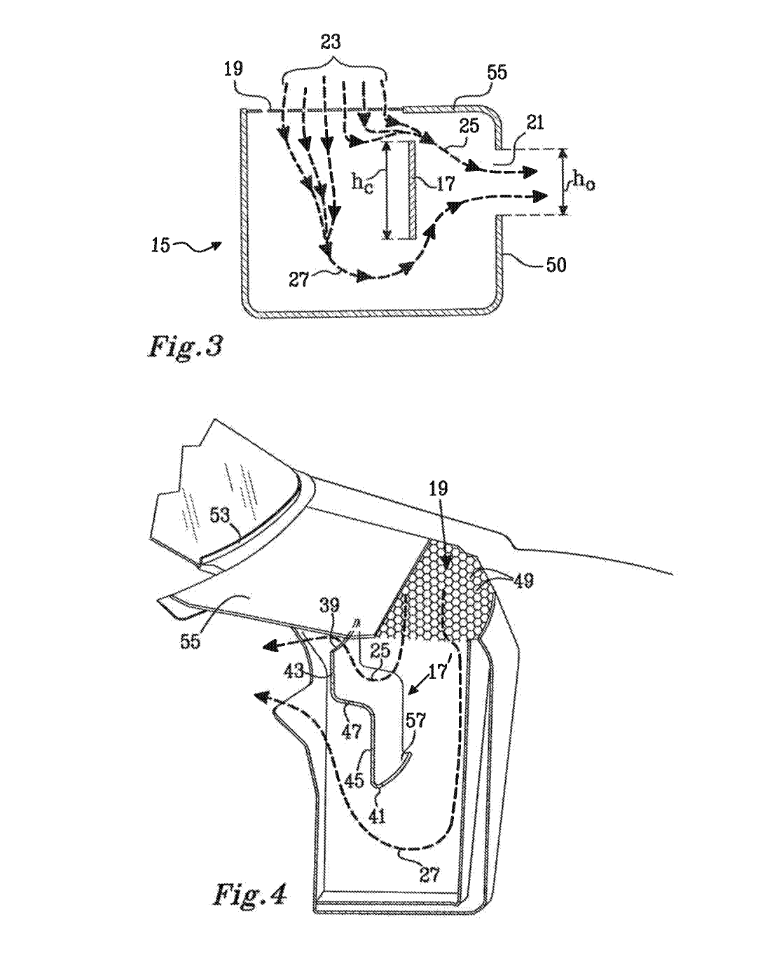

FIGS. 2 and 3 illustrate the air supply arrangement 3 according to a first embodiment of the disclosure in a perspective view seen from within a passenger compartment 13 of the vehicle, see FIG. 2 and in a cross-sectional view, see FIG. 3. The air supply arrangement 3 comprises a housing 15 and a cowl 17. The housing 15 has an air inlet 19 adapted to receive air from outside of the vehicle and an outlet 21 adapted to convey the air to a climate control system (not illustrated) of the vehicle 1. The cowl 17 is arranged inside the housing 15, such that the cowl 17 can split the entering air stream 23 into a first air stream portion 25 passing above the cowl 17 and a second air stream portion 27 passing below the cowl 17. The cowl 17 of the first embodiment has no opening and accordingly no air passes through the cowl 17. By allowing a portion of the entering air stream to go in the first air stream portion 25, it is possible to reduce the size of the air supply arrangement 3 as compared to existing air supply arrangements, wherein all the air goes in the correspondence to one of the air stream portions. For example, in the air supply arrangement of DE 43 03 663 C1 the air goes below the cowl, i.e., in the correspondence to the second air stream portion.

A main portion of the cowl 17 forms a wall 29, which has a substantially vertical cross-section. The direction may deviate a few degrees, e.g., less than 15 degrees, from vertical, in order to facilitate the assembly of the air supply arrangement 3. The cowl 17 is attached to the housing 15 at the lateral edges 31, 33 of the wall 29. The housing 15 comprises grooves 35, which are adapted to receive the lateral edges 31, 33. When assembling the air supply arrangement 3 the cowl 17 may thus be slid downwards in the grooves 35, thereby making it possible to mount the cowl 17 without any use of special tools. In addition, or as an alternative, the cowl 17 may be attached by any other known fastening means such as a clip, a screw or a nut and bolt connection or by welding or gluing. Alternatively, the cowl could be integrated in the housing 15, e.g., by being formed in one unit.

The first air stream portion 25 passes above an upper edge 39 of the cowl 17 and is redirected by more than 90 degrees. The second air stream portion 27 passes below a lower edge 41 of the cowl 17 and is also redirected by more than 90 degrees. The air passing closest to the cowl 17 is redirected by about 180 degrees.

The housing 15 is provided with a drainage system comprising a drainage opening 37, such that precipitation trapped in the air supply arrangement 3 can be drained from the housing 15. The drainage opening 37 is preferably provided with a valve arrangement (not illustrated), such that air is prevented from entering the air supply arrangement through the drainage opening 37.

The housing 15 forms a separate unit which is sealed from the engine compartment 9 of the vehicle 1. Thereby, no air may leak from the engine compartment 9 into the air supply arrangement 3. This is beneficial from an energy point of view, since air coming from the engine compartment would, assuming a warm engine, have a higher temperature than the outside air. Therefore, in operating conditions of the climate control system, when there is a need to cool the air to provide a comfortable climate in the passenger compartment, warm air from the engine compartment 9 would result in a need for additional cooling, which consumes energy. However, with the air supply arrangement 3 according to the disclosure as shown in FIGS. 2 and 3 comprising a drainage opening with a valve system, substantially no air can leak from the engine compartment 9 and thus such additional cooling can be avoided. In particular, the temperature level triggering the air conditioning to start may be raised by avoiding leakage of warm air into the air supply arrangement 3. In addition, the risk of allowing noise and/or smell from the engine compartment 9 into the air supply arrangement 3 is avoided or at least reduced.

The air inlet 19 is covered by a hole structure 49, in the illustrated embodiment exemplified by a perforated plate. The air inlet 19 may be integrated into a windshield base panel 51, as illustrated. In such case, the housing 15 is preferably connected to the windshield base panel 51 with a tight sealing such that substantially no air can leak into the air supply arrangement 3 besides the air stream 23 entering through the air inlet 19. A water deflector 53 is also shown, which prevents at least a main portion of the water flowing along the windshield from entering the air inlet 19. The hole structure 49 is located forward of the upper edge 39 of the cowl 17, such that the portion 55 of the housing 15 enclosing the upper edge 39 is air tight, thus forming a duct for the first air stream portion 25.

The cowl 17 is located such that it prevents the entering air stream 23 from directly reaching the outlet 21 of the air supply arrangement 3, which outlet 21 is positioned at a rear wall 50 of the housing 15 and is adapted to convey the air to the climate control system of the vehicle. Thereby the cowl 17 helps to prevent precipitation from reaching the climate control system. In the first embodiment, the cowl 17 is arranged such that it is large enough to cover the area of the outlet 21, in FIG. 3 represented by the height h_{c} of the cowl 17 overlapping and being greater than the height hₒ of the outlet 21, both heights being measured in the z-direction of the air supply arrangement 3 when mounted in the vehicle. However, due to the higher density of the precipitation, e.g., water drops, as compared to the air, the cowl 17 would also work in case it does not cover a lower portion of the outlet 21, since the water drops will due to gravity hit the rear wall 50 of the housing 15 below the outlet 21, although the second air stream portion 27 passes through the outlet. The lower edge 41 of the cowl 17 may thus be located above the lower edge of the outlet 21.

FIG. 4 shows a cross-sectional view of a second embodiment of an air supply arrangement 3. For simplicity, the same reference numbers are used for features, which are also present in the first embodiment shown in FIGS. 2 and 3. The first air stream portion 25 passes above the cowl 17′ and the second air stream portion 27 passes below the cowl 17′. The first air stream portion 25 changes direction, in the illustrated case by more than 90 degrees, when passing the upper edge 39 of the cowl. The second air stream portion 27 also changes direction by more than 90 degrees when passing the lower edge 41 of the cowl 17′. It changes from essentially vertically downwards to essentially vertically upwards, i.e., by about 180 degrees.

Similar as for the first embodiment, the air inlet 19 is covered by a hole structure 49 and a water deflector 53 prevents at least a main portion of the water flowing along the windshield from entering the air inlet 19. The hole structure 49 is located forward of the upper edge 39 of the cowl 17′, such that the portion 55 of the housing 15 enclosing the upper edge 39 is air tight, thus forming a duct for the first air stream portion 25.

The cowl 17′ is step-shaped and comprises a first substantially vertical portion 43, a second substantially vertical portion 45 being parallel to said first portion 43 and an intermediate transition portion 47 joining said first and second portions 43, 45. The second substantially vertical portion 45 is larger than the first portion 43 and forms a substantially vertical wall. The upper edge 39 of the cowl 17′ is located rearwards of the air inlet 19. Due to the step-shaped form of the cowl 17′, the upper edge 39 of the cowl 17′ is also located rearward of the lower edge 41. The step-shape of the cowl 17′ makes the housing 15 easier to fit in the vehicle 1.

FIG. 4 further illustrates that the cowl 17′ comprises a precipitation collection means 57, in this embodiment exemplified by a gutter around the lower edge 41 of the cowl 17′. The precipitation collection means 57 may be formed as an integral part of the cowl 17′, as illustrated, or it may be a separate part mounted to the cowl. The precipitation collection means 57 is arranged to collect the precipitation being carried by the second air stream portion 27. Preferably, the precipitation collection means 57 is inclined in relation to a horizontal plane of the vehicle 1 resulting in that any collected water flow in the gutter towards the lowest point, where a drainage arrangement (not illustrated) may be connected. Another precipitation collection means may be positioned at the upper edge 39 of the cowl 17′ arranged to collect the precipitation being carried by the first air stream portion 25. A similar precipitation collection means could also be used in the first embodiment.

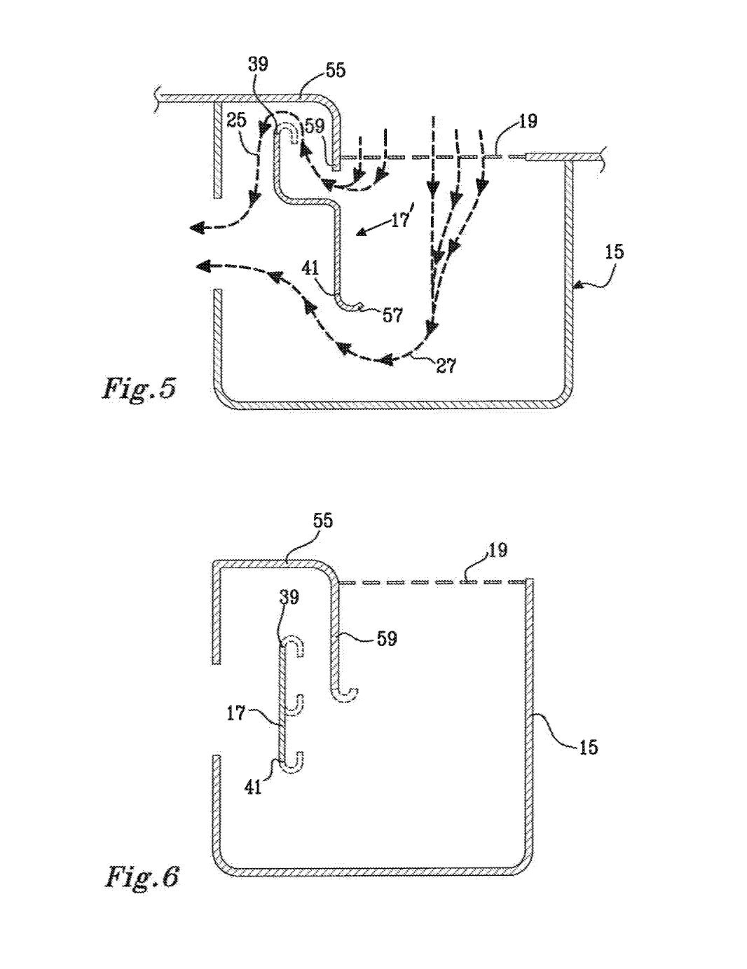

FIG. 5 illustrates a third embodiment of the disclosure. The cowl 17′ is step-shaped similar as for the second embodiment illustrated in FIG. 4. The portion 55 of the housing 15 enclosing the upper edge 39 of the cowl 17′ is located at a vertical level being above that of the air inlet 19. In addition, the housing 15 comprises a protrusion, here in the form of an additional wall 59 protruding into the housing 15 to a position being vertically below said upper edge 39 of the cowl 17′. The additional wall 59 is located forward of the upper edge 39 of the cowl 17′, such that a precipitation trap is formed for the first air stream portion 25, catching at least part of the precipitation carried by the first air stream portion 25 and thus preventing it from entering the climate control system of the vehicle. The additional wall 59 is preferably arranged such that the water may drop down along the cowl 17′ to the precipitation collection means 57 at the lower edge 41 of the cowl 17′. Alternatively, a precipitation collection means could be located at a lower edge of the additional wall 59. There may also be a precipitation collection means positioned at the upper edge 39 of the cowl 17′, see dashed lines. The precipitation collection means is preferably connected to the drainage system of the housing 15.

In a fourth embodiment, illustrated in FIG. 6, the portion 55 of the housing 15 enclosing the upper edge 39 of the cowl 17 is at the same vertical level as the air inlet 19. The cowl 17 comprises a substantially vertical wall, similar as for FIG. 2. Some alternative positions for the precipitation collection means are marked by dashed lines in FIG. 6: at the upper edge 39 of the cowl 17, at the lower edge 41 of the cowl 17, somewhere along the cowl 17 or at the lower edge of the additional wall 59.

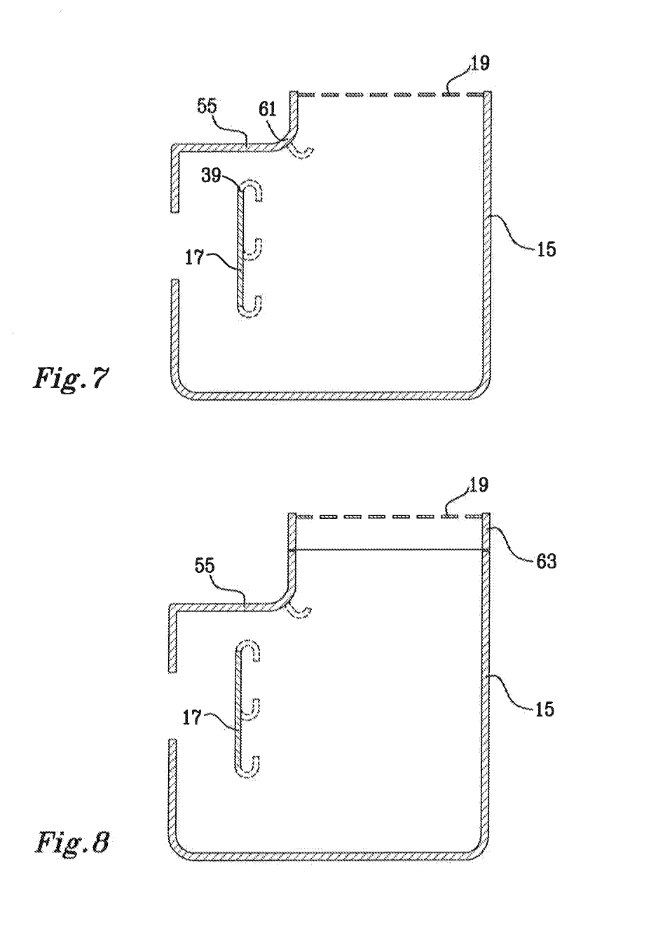

In a fifth embodiment, illustrated in FIG. 7 the protrusion forming the precipitation collection means for the first air stream portion 25 is formed by a step 61 in the cross-sectional shape of the portion 55 of the housing 15 enclosing the upper edge 39 of the cowl 17. The vertical level of the air inlet 19 is above the level of the portion 55 enclosing the upper edge 39. Some alternative positions for the precipitation collection means are marked by dashed lines, similar as for FIG. 6.

By using an adapter 63 in between the housing 15 and the air inlet 19, it is possible to use the same shape of the housing 15 for different vehicle models having different heights of the bonnet. The adapter 63 may have the same cross-section as the air inlet 19, as illustrated by FIG. 8 showing the air supply arrangement 3 of FIG. 7 combined with the adapter 63.

Other adapters may be used in combination with other embodiments of the disclosure. The adapter may have the same cross-section as the air inlet 19. Alternatively, the adapter could also encompass the portion 55 of the housing 15 located above the upper edge 39 or the whole top portion of the cowl. This would for example be suitable together with the fourth embodiment of FIG. 6. For some embodiments, the adapter preferably comprises one or more of the features comprised in the housing 15 in any of the first to fifth embodiments presented above. Purely as an example, the adapter may comprise an additional wall 59 like the additional wall 59 of the third or fourth embodiments or a precipitation collection means.

The adapter is preferably arranged such that an air-tight connection is formed between the adapter and the rest of the housing.

The dimensions of the housing 15 are preferably adapted to the dimensions of the vehicle. Purely as an example, the length of housing 15 may be between 10 and 100 centimetres, preferably between 20 and 80 centimetres and most preferably between 30 and 60 centimetres, with the length dimension of the housing 15 being the same as the width dimension of the vehicle, i.e., along the y axis of FIG. 2. Further, the width of the housing 15 may be between 5 and 50 centimetres, preferably between 10 and 40 centimetres and most preferably between 15 and 30 centimetres, with the width dimension of the housing 15 being the same as the length dimension of the vehicle, i.e., along the x axis of FIG. 2. Moreover, the height of the housing 15 may be between 10 and 50 centimetres, preferably between 15 and 50 centimetres and most preferably between 15 and 35 centimetres, with the height dimension being the same as the height dimension of the vehicle, i.e., along the z axis of FIG. 2. The dimensions of the housing 15 make up the dimensions of the air supply arrangement 3.

The dimensions of the cowl 17 are adapted to the dimensions of the housing 15. Purely as an example, the length of the cowl 17, in the y-direction of FIG. 2, may be between 10 and 50 centimetres, preferably between 15 and 40 centimetres. The width of the cowl 17, in the x-direction of FIG. 2, may be between 5 and 15 centimetres if step-shaped as in the second or third embodiments. The height, in the z-direction of FIG. 2, may be between 5 and 30 centimetres, preferably between 5 and 20 centimetres.

The precipitation collection means 57 may protrude by between 0.2 and 4 centimetres from the walls of the cowl 17, preferably by between 0.3 and 2 centimetres and most preferably between 0.5 and 1 centimetre.

Further modifications of the disclosure within the scope of the appended claims are feasible. As such, the present disclosure should not be considered as limited by the embodiments and figures described herein. Rather, the full scope of the disclosure should be determined by the appended claims, with reference to the description and drawings.

What is claimed is:

1. An air supply arrangement for a vehicle, the air supply arrangement comprising:
a housing comprising an air inlet adapted to receive an air stream from outside of the vehicle and an outlet adapted to convey the air stream to a vehicle climate control system; and
a cowl provided within the housing and arranged for splitting the air stream into at least two air stream portions including a first air stream portion that is able to pass between the cowl and a top portion of the housing, and a second air stream portion that is able to pass below the cowl.

2. The air supply arrangement according to claim 1 wherein the cowl is configured such that the first air stream portion is able to pass above the cowl.

3. The air supply arrangement according to claim 1 further comprising a stack of the cowls arranged interspaced on top of each other inside the housing, such that the first air stream portion is able to pass between the uppermost cowl and the top portion of the housing, the second air stream portion is able to pass below the lowest cowl, and an additional air stream portion is able to pass in between at least two of the cowls in the stack.

4. The air supply arrangement according to claim 1 wherein the air supply arrangement is configured such that at least 5% of the air stream that enters the air supply arrangement goes in the first air stream portion.

5. The air supply arrangement according to claim 1 wherein the air supply arrangement is configured such that at least 10% of the air stream that enters the air supply arrangement goes in the first air stream portion.

6. The air supply arrangement according to claim 1 wherein the air supply arrangement is configured such that at least 15% of the air stream that enters the air supply arrangement goes in the first air stream portion.

7. The air supply arrangement according to claim 1 wherein a main portion of the cowl forms a substantially vertical wall when mounted in the vehicle.

8. The air supply arrangement according to claim 1 wherein the cowl, when mounted in the vehicle and seen in cross-section from a side of the vehicle, comprises a first substantially vertical portion, a second substantially vertical portion substantially parallel to the first portion and an intermediate transition portion joining the first and second portions.

9. The air supply arrangement according to claim 1 wherein a portion of at least one lateral edge of the cowl is attached to the housing.

10. The air supply arrangement according to claim 9 wherein the cowl is only attached to the housing at at least a portion of one or both of its lateral edges.

11. The air supply arrangement according to claim 1 wherein the cowl further comprises a precipitation collection means arranged to collect precipitation carried by the first air stream portion or the second air stream portion from the outside of the vehicle and to remove the precipitation from the air stream portion.

12. The air supply arrangement according to claim 1 wherein an upper edge of the cowl is located at a higher vertical level than the air inlet when the air supply arrangement is mounted in the vehicle.

13. The air supply arrangement according to claim 1 wherein the cowl is configured to change the direction of the first air stream portion by at least 90 degrees when the first air stream portion passes an upper edge of the cowl.

14. The air supply arrangement according to claim 1 wherein an upper edge of the cowl is located at a position rearward of the air inlet when the air supply arrangement is mounted in the vehicle.

15. The air supply arrangement according to claim 1 wherein the housing comprises a protrusion protruding to a position vertically below an upper edge of the cowl, the protrusion being located forward of the upper edge of the cowl when the air supply arrangement is mounted in the vehicle.

16. The air supply arrangement according to claim 1 wherein the housing includes a portion that is located over the cowl, and wherein the portion is air tight.

17. A vehicle comprising an air supply arrangement according to claim 1.
